(19) United States
(12) Patent Application Publication
(10) Pub. No.: US 2014/0380030 A1
(43) Pub. Date: Dec. 25, 2014

(54) AUTOMATIC TURNING ON OF A DATA PROCESSING DEVICE DURING CHARGING OF A BATTERY SOURCE THEREOF

(71) Applicant: NVIDIA Corporation, Santa Clara, CA (US)

(72) Inventor: Chetan Jain, Pune (IN)

(21) Appl. No.: 13/923,395

(22) Filed: Jun. 21, 2013

(51) Int. Cl. G06F 1/26; G06F 11/30; G06F 9/44

(52) U.S. Cl. CPC G06F 1/26; G06F 9/4401; G06F 11/3058
USPC 713/2

(57) ABSTRACT

A method includes monitoring, through a charge monitor circuit associated with a data processing device and/or a battery source of the data processing device, a charge level of the battery source during charging thereof. The method also includes triggering, through a driver component provided in a non-volatile memory associated with the data processing device and/or a memory associated with the charge monitor circuit, loading of booting instructions onto the data processing device to initiate automatic turning on of the data processing device when the charge level of the battery source exceeds a threshold.

### FIELD OF TECHNOLOGY

This disclosure relates generally to data processing devices and, more particularly, to a method, a device and/or a system to automatically turn on a data processing device during charging of a battery source thereof.

### BACKGROUND

A data processing device (e.g., a mobile phone) may derive power from a battery source. A charge level of the battery source may have to sufficient enough for the data processing device to execute an operating system and application data thereon. When the charge level of the battery source falls below a threshold, the data processing device may automatically shut down. In order to turn on the data processing device for normal utilization, a user of the data processing device may have to wait until the battery source is charged to a reasonable level. The user may, therefore, not be able to be part of real-time communication through the data processing device during a time spent in charging the battery source.

### SUMMARY

Disclosed are a method, a device and/or a system to automatically turn on a data processing device during charging of a battery source thereof.

In one aspect, a method includes monitoring, through a charge monitor circuit associated with a data processing device and/or a battery source of the data processing device, a charge level of the battery source during charging thereof. The method also includes triggering, through a driver component provided in a non-volatile memory associated with the data processing device and/or a memory associated with the charge monitor circuit, loading of booting instructions onto the data processing device to initiate automatic turning on of the data processing device when the charge level of the battery source exceeds a threshold.

In another aspect, a non-transitory medium, readable through a data processing device and including instructions embodied therein that are executable through the data processing device, is disclosed. The non-transitory medium includes instructions to monitor, through a charge monitor circuit associated with the data processing device and/or a battery source of the data processing device, a charge level of the battery source during charging thereof. The non-transitory medium also includes instructions to trigger, through a driver component provided in a non-volatile memory associated with the data processing device and/or a memory associated with the charge monitor circuit, loading of booting instructions onto the data processing device to initiate automatic turning on of the data processing device when the charge level of the battery source exceeds a threshold.

In yet another aspect, a system includes a data processing device including a battery source, a charge monitor circuit associated with the data processing device and/or the battery source to monitor a charge level of the battery source during charging thereof, and a driver component provided in a non-volatile memory associated with the data processing device and/or a memory associated with the charging circuit. The driver component is configured to trigger loading of booting instructions onto the data processing device to initiate automatic turning on of the data processing device when the charge level of the battery source exceeds a threshold.

The methods and systems disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a schematic view of a data processing device including a battery source, according to one or more embodiments.

FIG. 2 is a schematic view of the data processing device of FIG. 1 having a charge monitor circuit as a part of control module thereof, according to one or more embodiments.

FIG. 3 is a schematic view of an alternate implementation of the charge monitor circuit of FIG. 2, according to one or more embodiments.

FIG. 4 is a schematic view of interaction between the driver component of FIGS. 2-3 and the battery source of FIG. 1, a processor of the data processing device of FIG. 1, a charger circuit of FIG. 1 and/or the charge monitor circuit of FIGS. 2-3, according to one or more embodiments.

FIG. 5 is a process flow diagram detailing the operations involved in automatically turning on the data processing device of FIG. 1 during charging of the battery source thereof, according to one or more embodiments.

Other features of the present embodiments will be apparent from the accompanying drawings and from the detailed description that follows.

### DETAILED DESCRIPTION

Example embodiments, as described below, may be used to provide a method, a system and/or a device to automatically turn on a data processing device during charging of a battery source thereof. Although the present embodiments have been described with reference to specific example embodiments, it will be evident that various modifications and changes may be made to these embodiments without departing from the broader spirit and scope of the various embodiments.

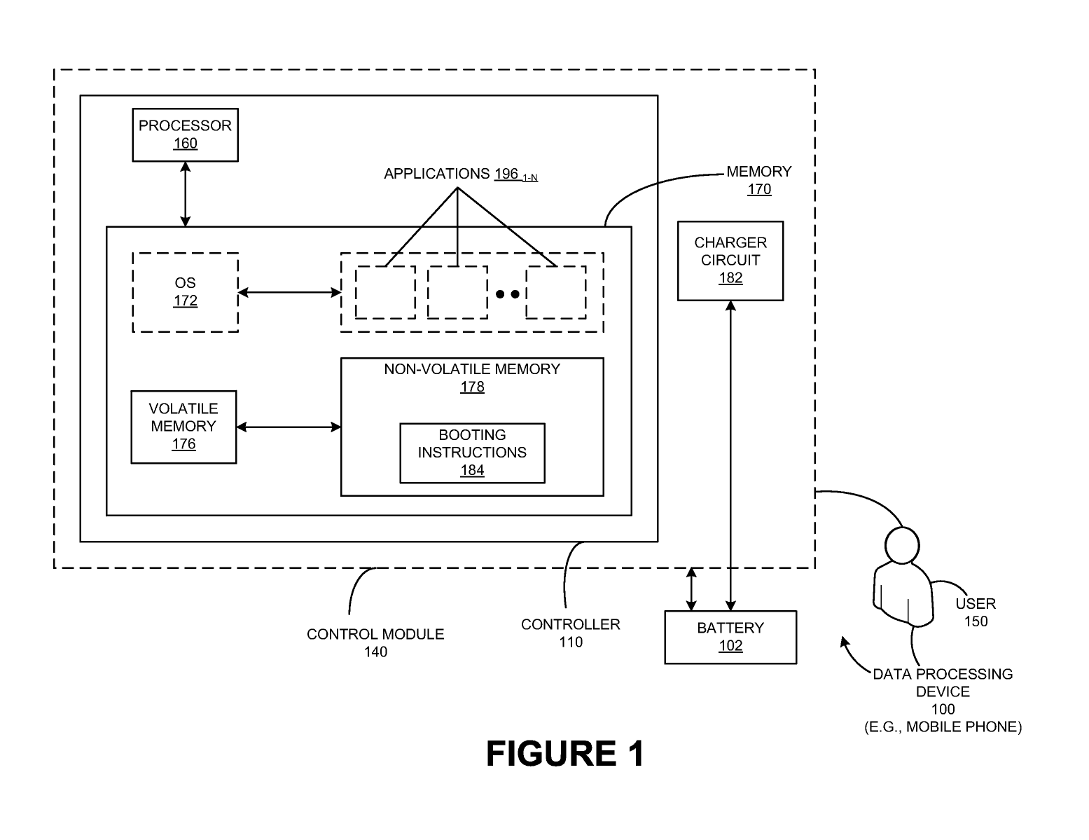

FIG. 1 shows a data processing device 100, according to one or more embodiments. In one or more embodiments, data processing device 100 may be a portable device (e.g., a mobile phone, a smart portable media player) or even a laptop, a desktop Personal Computer (PC), a notebook computer, a netbook and the like. While FIG. 1 shows a mobile phone as an example data processing device 100, other forms of data processing device 100 are within the scope of the exemplary embodiments discussed herein. In one or more embodiments, data processing device 100 may include a controller 110 (e.g., a processor 160 communicatively coupled to a memory 170 (e.g., a volatile memory and/or a non-volatile memory)) configured to control functionalities associated with data processing device 100. In one or more embodiments, memory 170 shown in FIG. 1 may include storage locations configured to be addressable through processor 160.

In one or more embodiments, an operating system (e.g., OS 172) may execute on data processing device 100; FIG. 1 shows operating system (e.g., OS 172) instructions as being stored in memory 170. Functionalities associated with a mobile phone are well known to one of ordinary skill in the art, and, therefore, FIG. 1 merely shows elements that are essential to understand concepts associated with the exemplary embodiments discussed herein. In one or more embodiments, as data processing device 100 may be configured to derive power from a battery 102, battery 102 is shown as being interfaced with a control module 140 including controller 110. It is obvious that control module 140 may include other elements necessary for the functioning of data processing device 100.

When data processing device 100 is turned off or a charge level of battery 102 falls below a threshold to trigger shutting down of data processing device 100, instructions associated with OS 172, data associated with applications (e.g., applications 196_{1-N}) executing on data processing device 100 et al. may be stored in non-volatile form(s) of memory 170. A user 150 of data processing device 100 may have to physically intervene (e.g., through pressing a button) in order to power on data processing device 100 back again. In the case of battery 102 being charged through a charger circuit 182, data processing device 100 may be capable of executing OS 172 and processing application data thereon once the charge level exceeds a threshold. However, user 150 may still need to intervene to turn on data processing device 100.

In the case of user 150 attempting to turn on data processing device 100 prior to the charge level exceeding the threshold, the boot up process associated therewith may fail. In the case of user 150 attempting to turn on data processing device 100 after the charge level exceeds the threshold, data processing device 100 may first execute a set of booting instructions (e.g., booting instructions 184) stored in a read-only memory (ROM) (example non-volatile form of memory 170; memory 170 shows a volatile memory 176 and a non-volatile memory 178 for example purposes; booting instructions 184 are shown as part of non-volatile memory 178), along with requisite data, to load OS 172 and application data onto volatile memory 176. However, as discussed above, user 150 may still need to physically intervene in order for data processing device 100 to perform the abovementioned processes.

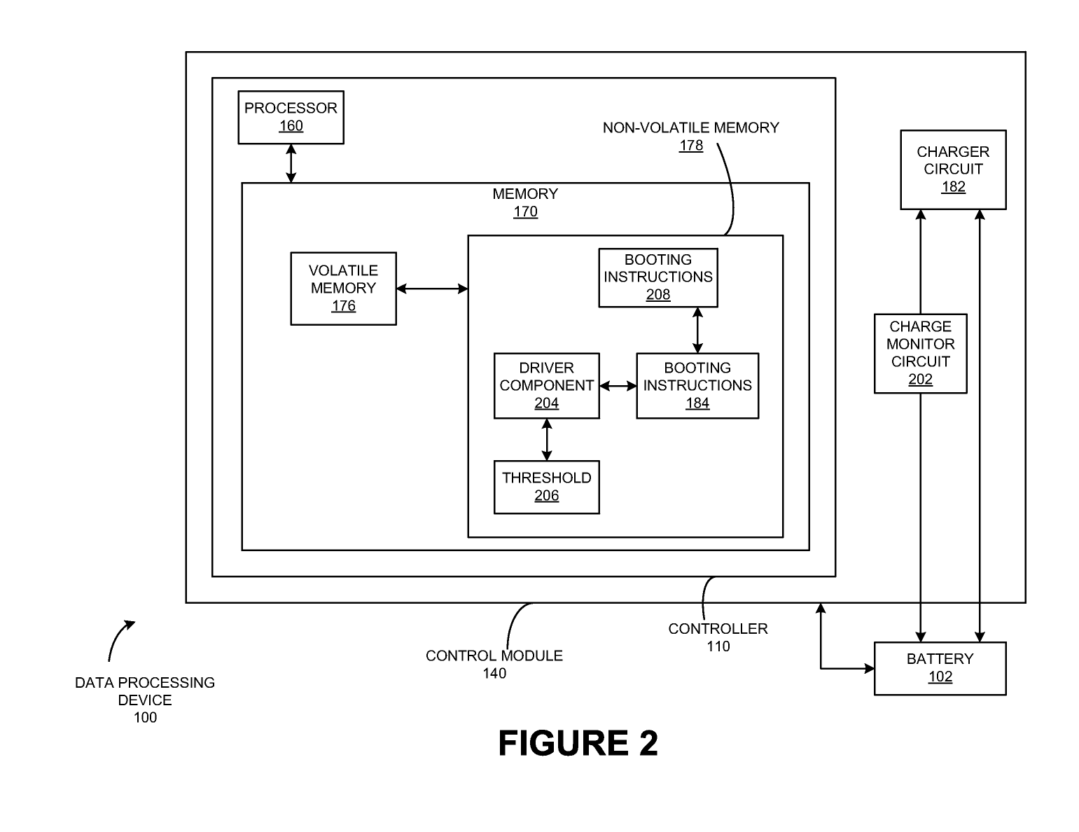

FIG. 2 shows data processing device 100 having a charge monitor circuit 202 as part of control module 140, according to one or more embodiments. In one or more embodiments, control module 140 may be configured to be powered up through charger circuit 182. In one or more embodiments, processor 160 may also be in an active state of operation during charging. In one or more embodiments, a driver component 204 (e.g., a set of instructions) may be provided in non-volatile memory 178 (e.g., firmware) to trigger the loading of booting instructions 184 on processor 160 once a charge level of battery 102 detected through charge monitor circuit 202 exceeds a threshold (e.g., threshold 206 stored in non-volatile memory 178; examples include 20% of maximum capacity, 25% et al.). In one or more other embodiments, processor 160 may be transitioned to the active state during the triggering of the loading of booting instructions 184 thereon through driver component 204.

It should be noted that threshold 206 may be dependent on a reasonable charge level (e.g., a bare minimum, a reasonable value, a fully charged state) of battery 102 that suffices for data processing device 100 to have all requisite data (e.g., OS 172, application data) loaded thereon during a normal mode of operation thereof. Threshold 206 may be predefined/hard-coded (e.g., through an Original Device Manufacturer (ODM) associated with data processing device 100, battery 102 et al.) in non-volatile memory 178.

In one or more embodiments, once processor 160 executes booting instructions 184 from non-volatile memory 178, another set of booting instructions 208 (e.g., also stored in non-volatile memory 178) may then load OS 172, application data et al. onto volatile memory 176. It should be noted that variations such as driver component 204 directly triggering the loading of booting instructions 184 onto volatile memory 176 from non-volatile memory 178, and processor 160 subsequently accessing said booting instructions 184 from volatile memory 176 are within the scope of the exemplary embodiments.

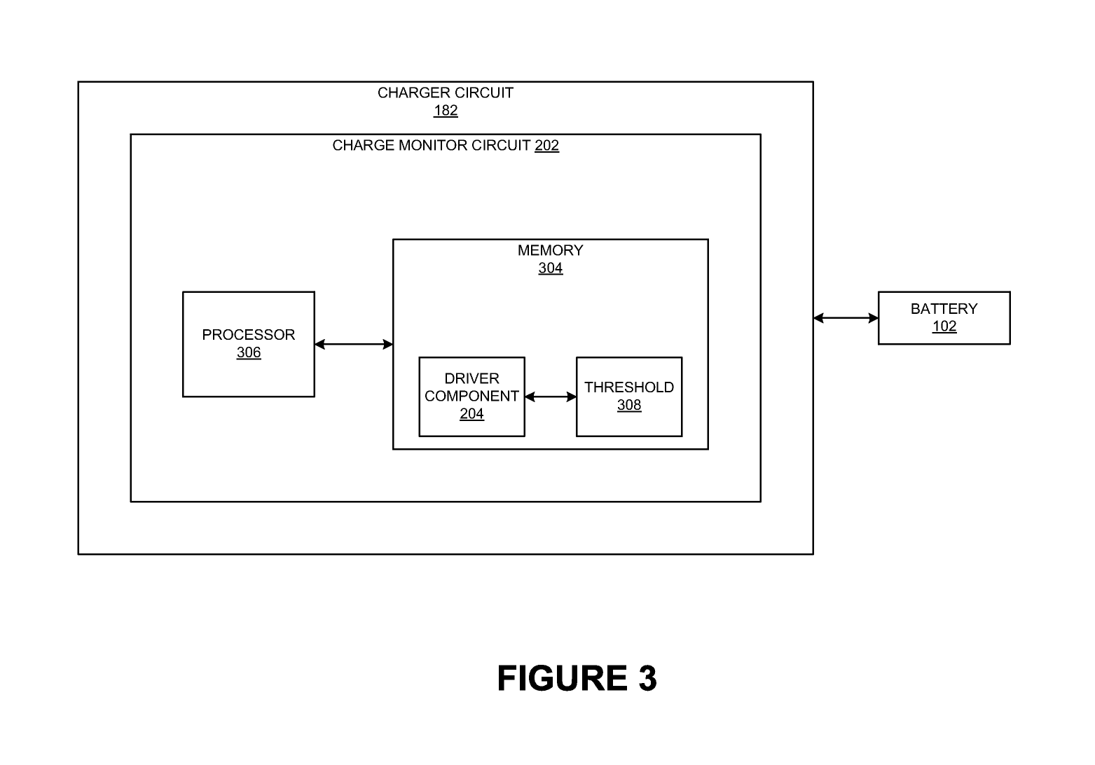

FIG. 3 shows an alternate implementation of charge monitor circuit 202; here, charge monitor circuit 202 may be part of charger circuit 182. Once again, in one or more embodiments, processor 160 may be in an active state of operation during charging of data processing device 100. In one or more embodiments, charge monitor circuit 202 may have a local memory 304 associated therewith; memory 304 may be communicatively coupled to a local processor 306, and may include driver component 204 stored therein. In one or more embodiments, driver component 204 may, again, trigger the loading of booting instructions 184 on processor 160 once the charge level detected through charge monitor circuit 202 exceeds a threshold (here, the threshold may be threshold 206 or a threshold 308 stored in memory 304). Here, the threshold comparison may occur through processor 306 or processor 160. Alternately, driver component 204 in non-volatile memory 178 may be leveraged to trigger the loading of booting instructions 184 on processor 160 once the charge level detected exceeds threshold 206.

Other operations related to the alternate implementation of FIG. 3 may be analogous to the operations related to the implementation discussed with regard to FIG. 2. Also, in one or more other embodiments, as discussed above, processor 160 may be transitioned to the active state during the triggering of the loading of booting instructions 184 through driver component 204 instead of being in the active state prior to the triggering.

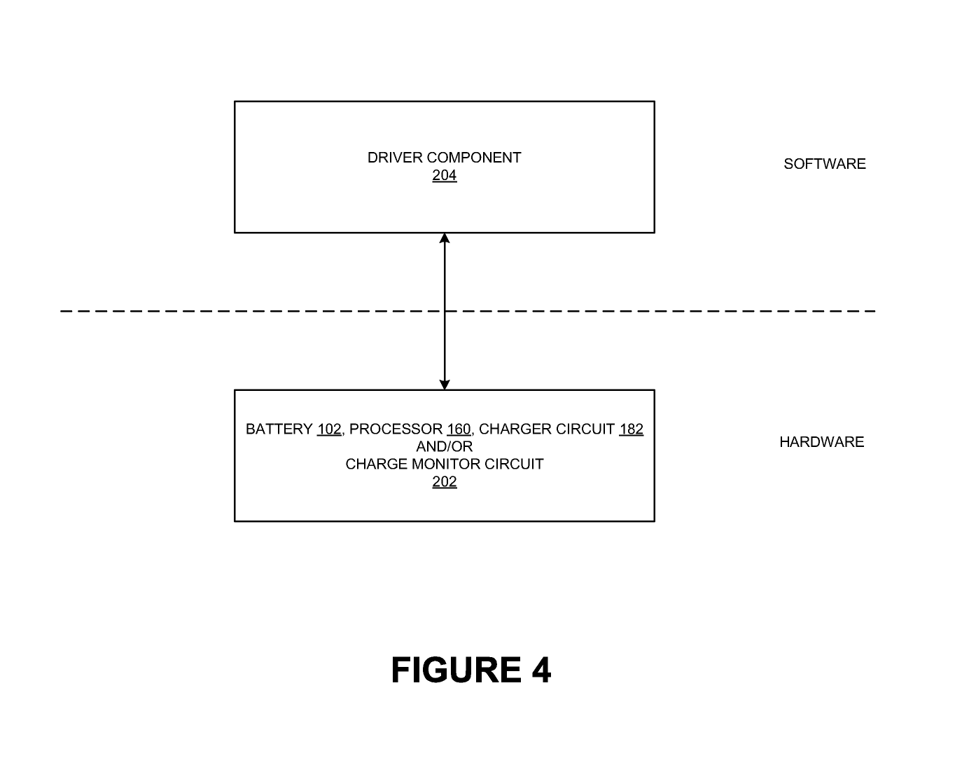

It should be noted that the implementation discussed with regard to FIG. 2 may coexist with the implementation discussed with regard to FIG. 3. In one or more embodiments, driver component 204 provided in non-volatile memory 178 and/or memory 304 may be associated with battery 102, processor 160, charger circuit 182 and/or charge monitor circuit 202. FIG. 4 shows interaction between driver component 204 and battery 102, processor 160, charger circuit 182 and/or charge monitor circuit 202, according to one or more embodiments. As discussed above, the triggering of the charge level detection and/or the loading of booting instructions 184 may be accomplished through driver component 204. In one or more embodiments, instructions associated with driver component 204 may be embodied in a non-transitory medium (e.g., a Compact Disc (CD), a Digital Video Disc (DVD), a Blu-Ray disc®, a non-volatile memory to which the instructions may be downloaded). Additionally or alternately, driver component 204 may be provided as part of an application 196_{1-N} and/or OS 172 executing on data processing device 100 that is configured to load driver component 204 onto non-volatile memory 178 during an active (or, normal) mode of operation of data processing device 100. All reasonable variations are within the scope of the exemplary embodiments discussed herein.

Further, charger circuit 182 and charge monitor circuit 202 are well known to one skilled in the art; therefore, detailed discussion associated therewith has been skipped for the sake of brevity and clarity. Exemplary embodiments, as discussed above, provide for a means to automatically turn on data processing device 100 during charging of battery 102 thereof.

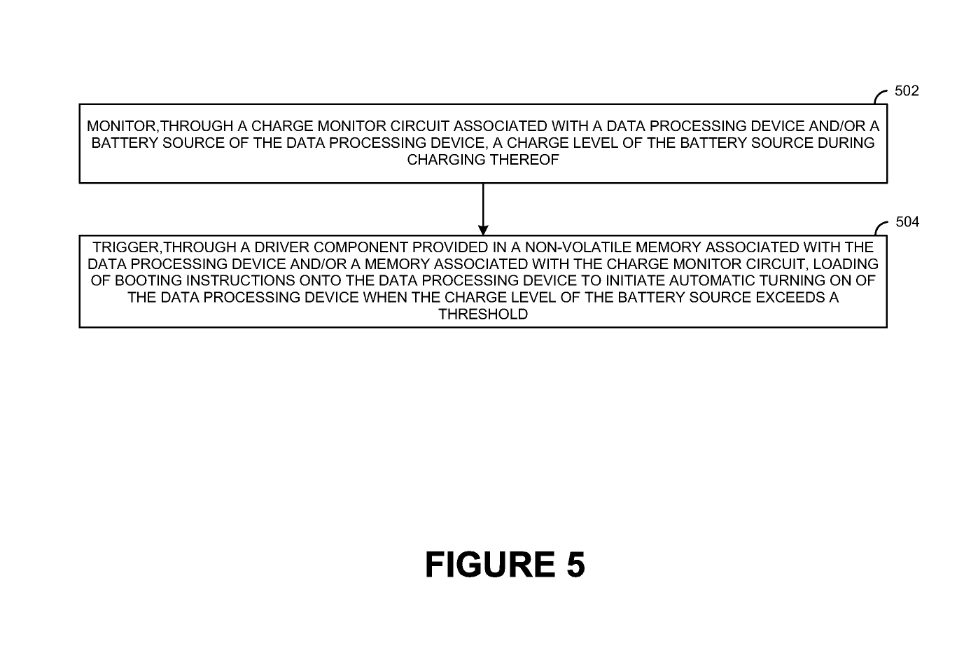

FIG. 5 shows a process flow diagram detailing the operations involved in the abovementioned automatic turning on of data processing device 100 during charging of battery 102 thereof, according to one or more embodiments. In one or more embodiments, operation 502 may involve monitoring, through charge monitor circuit 202 associated with data processing device 100 and/or a battery source (e.g., battery 102) thereof, a charge level of the battery source during charging thereof. In one or more embodiments, operation 504 may then involve triggering, through driver component 204 provided in non-volatile memory 178 associated with data processing device 100 and/or memory 304 associated with charge monitor circuit 202, loading of booting instructions 184 onto data processing device 100 to initiate automatic turning on of data processing device 100 when the charge level of the battery source exceeds a threshold.

Although the present embodiments have been described with reference to specific example embodiments, it will be evident that various modifications and changes may be made to these embodiments without departing from the broader spirit and scope of the various embodiments. For example, the various devices and modules described herein may be enabled and operated using hardware circuitry (e.g., CMOS based logic circuitry), firmware, software or any combination of hardware, firmware, and software (e.g., embodied in a machine readable medium). For example, the various electrical structure and methods may be embodied using transistors, logic gates, and electrical circuits (e.g., application specific integrated (ASIC) circuitry and/or Digital Signal Processor (DSP) circuitry).

In addition, it will be appreciated that the various operations, processes, and methods disclosed herein may be embodied in a machine-readable medium and/or a machine accessible medium compatible with a data processing system (e.g., data processing device 100). Accordingly, the specification and drawings are to be regarded in an illustrative rather than a restrictive sense.

What is claimed is:

1. A method comprising:
monitoring, through a charge monitor circuit associated with at least one of a data processing device and a battery source of the data processing device, a charge level of the battery source during charging thereof; and
triggering, through a driver component provided in at least one of: a non-volatile memory associated with the data processing device and a memory associated with the charge monitor circuit, loading of booting instructions onto the data processing device to initiate automatic turning on of the data processing device when the charge level of the battery source exceeds a threshold.

2. The method of claim 1, wherein triggering the loading of the booting instructions comprises triggering the loading of the booting instructions on a processor of the data processing device communicatively coupled to the at least one of the non-volatile memory and the memory associated with the charge monitor circuit.

3. The method of claim 2, further comprising executing another set of booting instructions stored in the non-volatile memory to load an operating system and application data configured to execute on the data processing device onto a volatile memory associated with the data processing device following execution of the booting instructions on the processor.

4. The method of claim 1, comprising:
directly triggering, through the driver component, the loading of the booting instructions onto a volatile memory associated with the data processing device from the non-volatile memory; and
accessing, through a processor of the data processing device, the booting instructions from the volatile memory.

5. The method of claim 1, further comprising:
at least one of predefining and hard-coding the threshold in the non-volatile memory; and
performing the comparison between the charge level and the threshold through at least one of: a processor associated with the data processing device and a processor associated with the charge monitor circuit.

6. The method of claim 1, comprising providing the driver component as a driver component of at least one of: the battery source, a processor of the data processing device, the charge monitor circuit and a charger circuit configured to charge the battery source.

7. The method of claim 1, comprising providing the driver component as part of at least one of an application and an operating system configured to execute on the data processing device.

8. A non-transitory medium, readable through a data processing device and including instructions embodied therein that are executable through the data processing device, comprising:
instructions to monitor, through a charge monitor circuit associated with at least one of the data processing device and a battery source of the data processing device, a charge level of the battery source during charging thereof; and
instructions to trigger, through a driver component provided in at least one of: a non-volatile memory associated with the data processing device and a memory associated with the charge monitor circuit, loading of booting instructions onto the data processing device to initiate automatic turning on of the data processing device when the charge level of the battery source exceeds a threshold.

9. The non-transitory medium of claim 8, wherein the instructions to trigger the loading of the booting instructions comprise instructions to trigger the loading of the booting instructions on a processor of the data processing device communicatively coupled to the at least one of the non-volatile memory and the memory associated with the charge monitor circuit.

10. The non-transitory medium of claim 9, further comprising instructions to execute another set of booting instructions stored in the non-volatile memory to load an operating system and application data configured to execute on the data processing device onto a volatile memory associated with the data processing device following execution of the booting instructions on the processor.

11. The non-transitory medium of claim 8, comprising:
instructions to directly trigger, through the driver component, the loading of the booting instructions onto a volatile memory associated with the data processing device from the non-volatile memory; and
instructions to access, through a processor of the data processing device, the booting instructions from the volatile memory.

12. The non-transitory medium of claim 8, further comprising:
instructions to at least one of predefine and hard-code the threshold in the non-volatile memory; and
instructions to perform the comparison between the charge level and the threshold through at least one of: a processor associated with the data processing device and a processor associated with the charge monitor circuit.

13. The non-transitory medium of claim 8, comprising instructions compatible with the driver component being a driver component of at least one of: the battery source, a processor of the data processing device, the charge monitor circuit and a charger circuit configured to charge the battery source.

14. A system comprising:
a data processing device comprising a battery source;
a charge monitor circuit associated with at least one of the data processing device and the battery source to monitor a charge level of the battery source during charging thereof; and
a driver component provided in at least one of: a non-volatile memory associated with the data processing device and a memory associated with the charging circuit to trigger loading of booting instructions onto the data processing device to initiate automatic turning on of the data processing device when the charge level of the battery source exceeds a threshold.

15. The system of claim 14, wherein the driver component is configured to trigger the loading of the booting instructions on a processor of the data processing device communicatively coupled to the at least one of the non-volatile memory and the memory associated with the charge monitor circuit.

16. The system of claim 15, wherein the data processing device is further configured to execute another set of booting instructions stored in the non-volatile memory to load an operating system and application data configured to execute thereon onto a volatile memory associated therewith following execution of the booting instructions on the processor.

17. The system of claim 14,
wherein the driver component is configured to directly trigger the loading of the booting instructions onto a volatile memory associated with the data processing device from the non-volatile memory, and
wherein the data processing device further comprises a processor to access the booting instructions from the volatile memory.

18. The system of claim 14,
wherein the threshold is at least one of: predefined and hard-coded in the non-volatile memory, and
wherein at least one of: a processor associated with the data processing device and a processor associated with the charge monitor circuit is configured to perform the comparison between the charge level and the threshold.

19. The system of claim 14, wherein the driver component is provided as a driver component of at least one of: the battery source, a processor of the data processing device, the charge monitor circuit and a charger circuit configured to charge the battery source.

20. The system of claim 14, wherein the driver component is provided as part of at least one of an application and an operating system configured to execute on the data processing device.
